(19) United States
(12) Patent Application Publication
(10) Pub. No.: US 2009/0267905 A1
(43) Pub. Date: Oct. 29, 2009

(54) Cursor Input Device With Dual Input Modes

(76) Inventors: Chung-Wen Hsu, Hsinchu (TW); Chia-Te Huang, Hsinchu (TW); Cheng-Tai Huang, Hsinchu (TW); Chang-Chin Lai, Hsinchu (TW)

Correspondence Address: LIN & ASSOCIATES INTELLECTUAL PROPERTY, INC., P.O. BOX 2339, SARATOGA, CA, 95070-0339, US

(21) Appl. No.: 12/110,288

(22) Filed: Apr. 26, 2008

(51) Int. Cl. G06F 3/041

(52) U.S. Cl. 345/173

(57) ABSTRACT

A cursor input device with dual input modes is provided, including a control computing module, a coordinate sensing module, a first analog multiplexing module, a first signal processing module, a second analog multiplexing module and a second signal processing module, where the coordinate sensing module further including a touch sensing loop unit and an electromagnetic sensing loop unit. The control computing module at least includes a microprocessor. The control computing module uses the first analog multiplexing unit and the first signal processing module to enable the electromagnetic sensing loop unit to perform signal scanning and processing, and uses the second analog multiplexing unit and the second signal processing module to enable the touch sensing loop unit to perform signal scanning and processing. In this manner, the user can use either touch input mode or electromagnetic pen input mode to control the cursor of the present invention to execute various the application software or operating system.

### FIELD OF THE INVENTION

The present invention generally relates to a cursor input device, and more specifically to a cursor input device with both electromagnetic pen and touch panel modes.

### BACKGROUND OF THE INVENTION

The continuous progress in touch panel technology lowers the manufacture cost and enables the wide range of applications of touch panels. For example, the information kiosk at public locations, ATM machines, thin notebook PC, tablet PC, PDA, electronic dictionary, mobile phone, MP3 player and GPS.

Two major categories of touch panel technologies are used. The first category is the resistor-based, and the second category is the capacitor-based. The resistor-based touch panel is based on the pressure generated by the touch on the panel so that the upper layer conductive membrane and the lower layer conductive membrane contact and the voltage drops. The touch point of the pressure can then be calculated to obtain the X-axis and Y-axis. This is the most popular technique used in touch panel. The advantages are simple structure, less components, and good yield rate, while the disadvantages are not abrasion resistant and low transmittance. The capacitor-based touch panels are divided into the surface capacitance type and projected capacitance type. The surface capacitance type is to generate a uniform electrical field on the glass surface. When the finger touches the glass, the finger will generates a capacitance coupling with the electrical field on the outer conductive layer to drain the micro current. Then, the current drain ratio is computed and the controller can determine the coordinates of the location touched by the finger. The advantages of the surface capacitance type touch panel are waterproof, abrasion resistant, high transmittance and applicable to a wide temperature range, while the disadvantages are complicated manufacturing process, higher complexity of driver IC and circuit, higher manufacturing cost, and requiring hand or other conductive media for operation. On the other hand, the projected capacitance type, also called matrix capacitance or digital capacitance type, touch panel uses the changes of the static electrical field on the sensor matrix to determine the location of the touch. When the finger touches the panel, a capacitance formed between the finger and the matrix. The controller uses the change in matrix electrical parameter to compute the coordinates of the location of the touch. The advantages to projected capacitance type touch panel include that no recalibration is required for location and the capability to sense the touch even through a thicker layer. However, while the touch panel allows the user to use the finger to control the cursor conveniently, the overall shortcoming of a touch panel is that it is applicable only to simple drawing or interface operation.

On the other hand, when a user needs to perform precise drawing, the digital board is good alternative. The digital board is a writing input device with electromagnetic sensing capability. The user needs to use specific electromagnetic pen for cursor control input. When the digital board senses the signals from the electromagnetic pen, the signals detected by the X-axis and Y-axis scanning loops can be computed to obtain the location of the cursor and the applied pressure.

Currently in the market, the touch panel and the digital board are two separate products, and the user can only use a single input mode, i.e., touch or electromagnetic pen, when operating on these two separate products. Therefore, it is imperative to device a product that both input modes can be used to control the cursor in order to enable more convenience in use.

### SUMMARY OF THE INVENTION

The primary object of the present invention is to provide a cursor input device with dual input modes. The dual input modes are finger touch and the electromagnetic pen, so that a single cursor input device can uses suitable input mode according to the type of application. In addition, the cursor input device of the present invention can automatically select the respective signal processing process according to the input mode so that the user does not need to manually switch to different input mode.

Another object of the present invention is to provide a cost-effective cursor input device. While the cursor input device has two input modes, the manufacturing cost will not be doubled. The manufacturing cost of the present invention will comparable to the manufacturing cost of the conventional digital board. Therefore, the present invention is cost effective and more market competitive.

Yet another object of the present invention is to provide a cursor input device applicable to a wider range of applications and more convenient to use. The present invention can be integrated with software and firmware to provide better performance and efficiency. For example, in an application, a user can use finger to draw or sketch a draft in a fast and convenient manner and then uses the electromagnetic pen for precise drawing or refining the sketched draft. Or, the designer can utilize the advantage of each input mode so that different usages can be defined in the product to allow the user more flexible operation. For example, when using computer in web browsing or searching, the touch input mode can be used, while in the precise graphical design or writing recognition, the electromagnetic pen input mode can be automatically switched to.

To achieve the above objects, the present invention provides a cursor input device with dual input modes, including a control computing module, a coordinate sensing module, a first analog multiplexing module, a first signal processing module, a second analog multiplexing module and a second signal processing module, where the coordinate sensing module further including a touch sensing loop unit and an electromagnetic sensing loop unit. The control computing module at least includes a microprocessor. The control computing module uses the first analog multiplexing unit and the first signal processing module to enable the electromagnetic sensing loop unit to perform signal scanning and processing, and uses the second analog multiplexing unit and the second signal processing module to enable the touch sensing loop unit to perform signal scanning and processing. In this manner, the user can use either touch input mode or electromagnetic pen input mode to control the cursor of the present invention.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a block diagram of the cursor input device with dual input modes according to the invention;

FIG. 2 shows a flowchart of the operation of the cursor input device of the present invention;

FIG. 3 shows a cross-sectional view of the first embodiment of the coordinate sensing module of the cursor input device of the present invention;

FIG. 4 shows an enlarged cross-sectional view of the second embodiment of the coordinate sensing module of the cursor input device of the present invention;

FIG. 5 shows a schematic view of the third embodiment of the coordinate sensing module of the cursor input device of the present invention; and

FIG. 6 shows a cross-sectional view of the fourth embodiment of the coordinate sensing module of the cursor input device of the present invention.

### DETAILED DESCRIPTION OF THE PREFERRED EMBODIMENTS

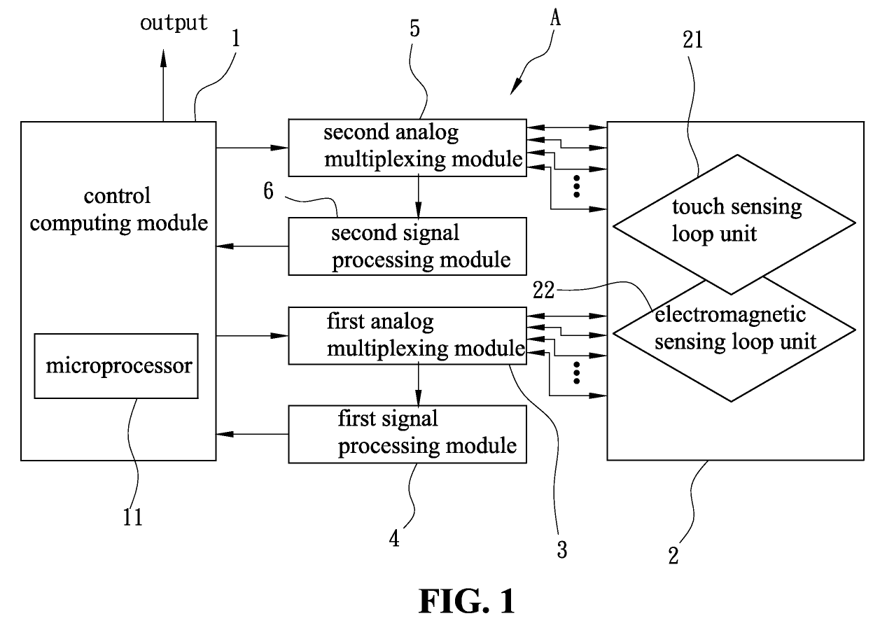

FIG. 1 shows a block diagram of a cursor input device with dual input modes of the present invention. As shown in FIG. 1, a cursor input device A includes a control computing module 1, a coordinate sensing module 2, a first analog multiplexing module 3, a first signal processing module 4, a second analog multiplexing module 5, and a second signal processing module 6. Coordinate sensing module 2 can accept the input either by finger touch or electromagnetic pen. Control computing module 1 uses analog multiplexing modules to scan the signal input by finger touch or the electromagnetic pen, and then the signal processing modules process the sensed signal. The processed signals are computed and output by microprocessor 11 of control computing module. Therefore, cursor input device A of the present invention can accept two different input modes.

The following describes the details of the components. Coordinate sensing module 2 includes a touch sensing loop unit 21 and an electromagnetic sensing loop unit 22. Touch sensing loop unit 21 and electromagnetic sensing loop unit 22 are structured in a layered manner. That is, Touch sensing loop unit 21 and electromagnetic sensing loop unit 22 can be layout in separate layers or layered in an interleaved manner. Touch sensing loop unit 21 of the present embodiment is a capacitance-based touch structure, and more specifically, a projected capacitance touch structure.

First analog multiplexing module 3 is connected between control computing module 1 and coordinate sensing module 2. First analog multiplexing module 3 is to work with electromagnetic sensing loop unit 22. Control computing module 1 uses first analog multiplexing module 3 to enable electromagnetic sensing loop unit 22 to activate the corresponding loops to scan for signals. First signal processing module 4 is connected between control computing module 1 and first analog multiplexing module 3. First signal processing module 4 includes a signal amplification circuit, an automatic gain control circuit, a filter, and so on, so as to process the signal sensed by electromagnetic sensing loop unit 22 and to transmit the processed signal to control computing module 1.

Second analog multiplexing module 5 is connected between control computing module 1 and coordinate sensing module 2. Second analog multiplexing module 5 is to work with touch sensing loop unit 21. Control computing module 1 uses second analog multiplexing module 5 to enable touch sensing loop unit 21 to activate the corresponding loops to scan for signals. Second signal processing module 6 is connected between control computing module 1 and second analog multiplexing module 5. Second signal processing module 6 is to process the signal sensed by touch sensing loop unit 21 and to transmit the processed signal to control computing module 1.

Control computing module 1 further includes at least a microprocessor 11. Control computing module 1, in addition to drive first analog multiplexing module 3 and second analog multiplexing module 5, will also compute the processed signals from first signal processing module 4 and second signal processing module 6, and then outputs the computation result, such as to a system host, for example, PC. The transmission interface for control computing module 1 to system host can be either wired or wireless transmission.

In general, when using cursor input device A of the present invention, if a user uses both electromagnetic pen input mode and touch input mode simultaneously, cursor input device A will give higher priority to the receiving and processing of signals from the electromagnetic input mode. When no electromagnetic signal is sensed, cursor input device A will then process any touch signal sensed. Therefore, the signals from two input modes will not interfere with each other. Hence, when a user uses electromagnetic pen to draw on cursor input device A of the present invention, the touch sensing mode will not be activated even though the user's hand may touch the cursor input device. This is because the electromagnetic input mode takes a higher priority.

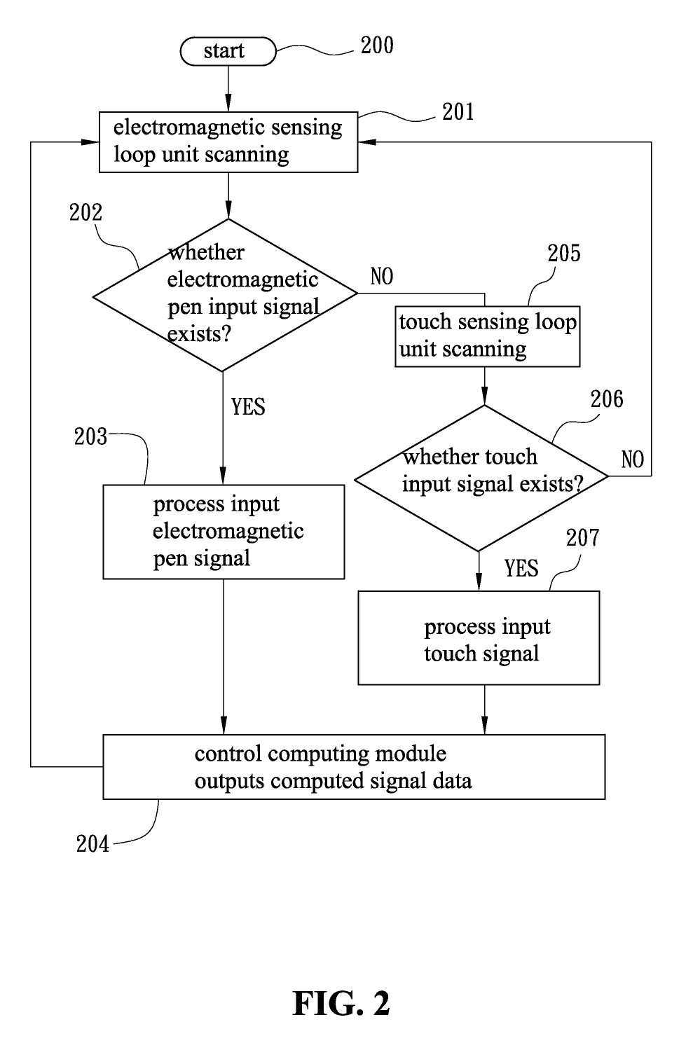

The following describes the operation of the present invention. FIG. 2 shows a flowchart of the operation of the present invention, and the following description also refers to FIG. 1. A shown in FIG. 2, step 200 is for cursor input device A to enter the start state. Step 201 is for the electromagnetic sensing loop unit to scan for signals, in which control computing module 1 drives first analog multiplexing module 3 to activate electromagnetic sensing loop unit 22 of coordinate sensing module 2 to scan for signals.

Step 202 is to determine whether a signal from electromagnetic pen is detected. If so, proceed to step 203; otherwise, proceed to step 205. It is worth noting that, in this step, control computing module 1, after receiving the result from first signal processing unit 4 processing the sensing result from electromagnetic sensing loop unit 22, will determines which step to take.

Step 203 is to perform the computing on the electromagnetic signals. Control computing module, after receiving the electromagnetic pen signals, still uses first analog multiplexing module 3 to keep electromagnetic sensing loop unit scanning, for example, scanning the left and right sensing antenna loops on both sides of the sensing antenna loop with the strongest signal, capture the sensed signals, compute the pressure of the electromagnetic pen and the button signal of the electromagnetic pen, and so on. Then, control computing module 1, through the computation and fine-tuning of microprocessor 11, computes the required data, such as, coordinates and pressure.

Step 204 is for control computing module 1 to output the computed data, and returns to step 201 for further signal scanning.

When no signals from electromagnetic pen are detected, step 205 is taken. In step 205, touch sensing loop unit 22 is activated for signal scanning. Similarly, in this step, control computing module 1 drives second analog multiplexing module 5 to enable touch sensing loop unit 21 of coordinate sensing module 2 to scan for signals.

Step 206 is to determine whether signals from the touch input can be detected. If so, proceed to step 207; otherwise, return to step 201 to wait for electromagnetic scanning. In this step, control computing 1, after receiving the result from second signal processing module 2 processing the result from touch sensing loop unit 21, determines the subsequent operation.

Step 207 is to perform the computing on the touch signals. Touch sensing loop unit 21 transmits the sensed touch signal to second signal processing module 4 for processing and then transmits the processed signal to control computing module 1. Control computing module 1 computes the equation with appropriate antenna signal to obtain the coordinate data. Then, take step 204 to output coordinate data, and return to step 201. In this manner, the present invention can accept input from two input modes, but only input from one input mode can be processed at one time, and no interference will occur.

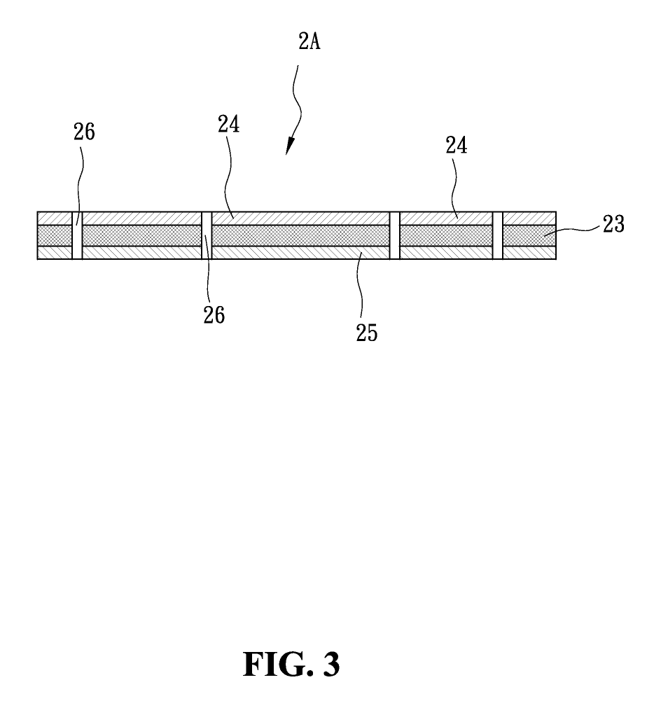

Coordinate sensing module 2 of the present invention can be realized in many different manners. The present invention provides four structures for description, but the present invention is not restricted by the four structures disclosed in this application. As shown in FIG. 3, coordinate sensing module 2A is a printed circuit board (PCB). In this embodiment, signal circuit layers 24, 25 are formed respectively on the two surfaces of a PCB 23. Signal circuit layers 24, 25 are the interleaved circuits for touch sensing loops and electromagnetic sensing loops, respectively. PCB 23 further includes a plurality of holes 26. Holes 26 penetrate PCB 23 and each signal circuit layer. The inner wall of holes 26 are conductive layer for electrical connection of the circuits of each layer.

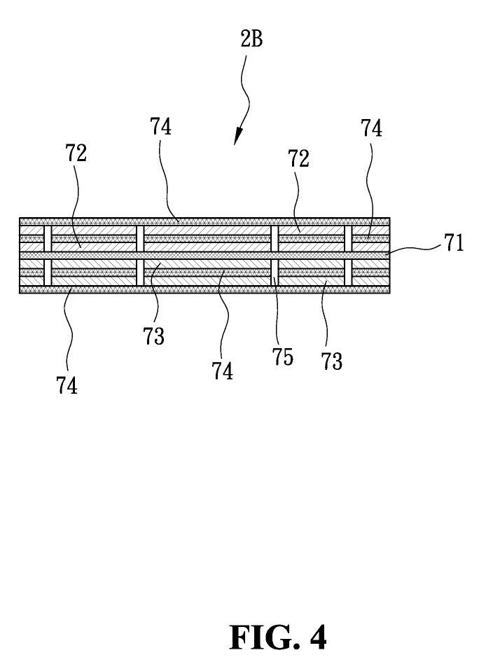

FIG. 4 shows an enlarged view of the second embodiment of the coordinate sensing module of the present invention. In this embodiment, coordinate sensing module 2B is a soft membrane circuit board. The structure of the membrane circuit board includes a soft circuit board substrate 71 in the middle, a plurality of signal circuit layers 72, 73 are formed on the upper surface and the lower surface of soft circuit board substrate 71, with a plurality of circuit isolation layers 74 isolating the top layer of and between signal circuit layers 72 on the upper surface, and a plurality of circuit isolation layers isolating 74 the bottom layer of and between signal circuit layers 73 on the lower surface. Signal circuit layers 72 are for the touch sensing loop unit, and signal circuit layers 73 are for the electromagnetic sensing loop unit. A plurality of holes 75 penetrates the signal circuit layers and has conductive inner wall for electrically connecting each circuit on each layer.

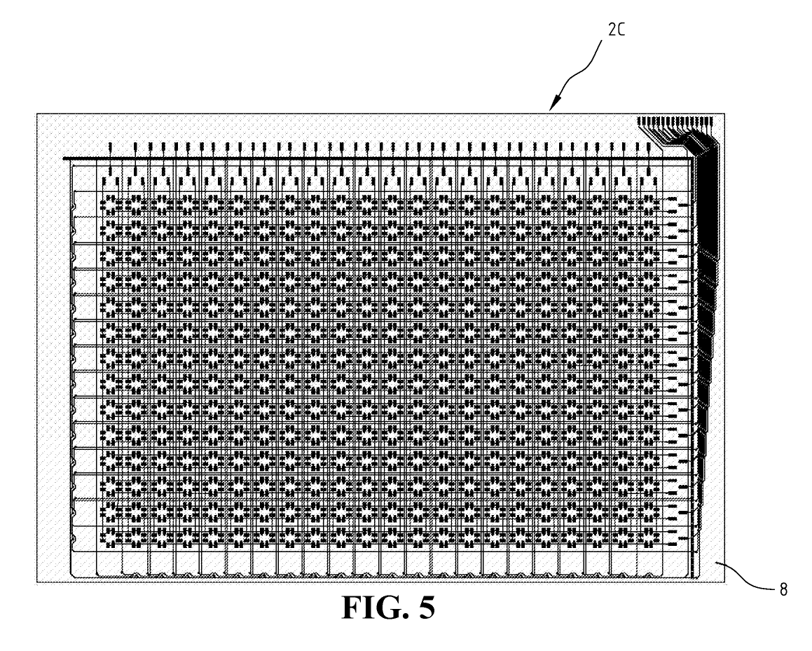

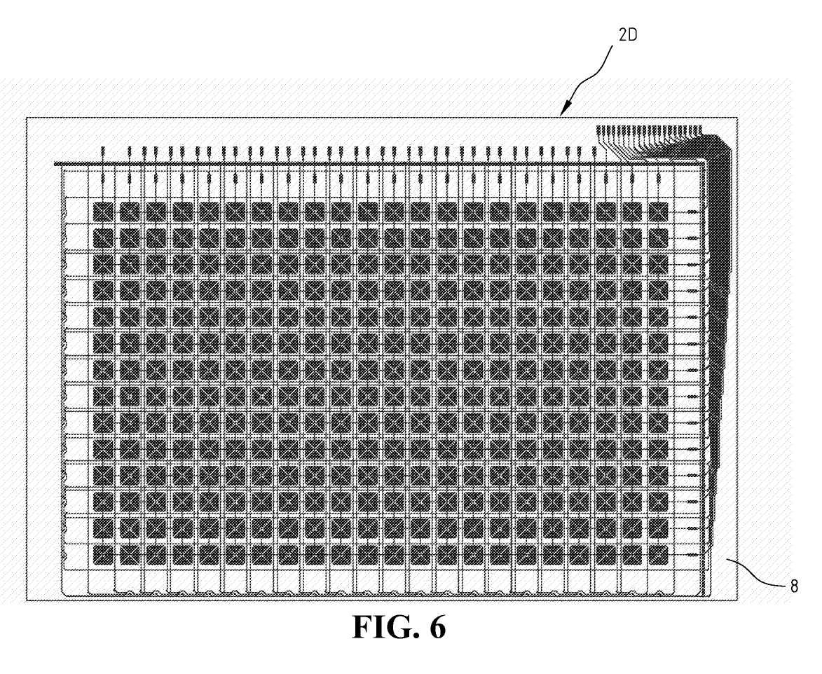

FIG. 5 and FIG. 6 show the third and the fourth embodiments of the coordinate sensing module of the present invention. The only difference between these two embodiments is the circuit layout pattern of coordinate sensing module 2C and coordinate sensing module 2D, while the manufacturing process remains the same. Coordinate sensing modules 2C, 2D forms the circuit on substrate 8. Substrate 8 can be a circuit board, glass, and so on. The circuit is an interleaved layered circuit, forming both touch sensing loop unit and electromagnetic sensing loop unit at the same time. Therefore, it is clear that the coordinate sensing module 2 of the present invention is not limited to any specific structure.

In summary, the cursor input device of the present invention allows two input modes on a single device that the user can either use finger touch or electromagnetic pen for input. When using electromagnetic pen, the user can perform precise graphic drawing with precise control of the cursor and the pressure sensing. When using finger touch, the user can draw sketchy in a fast and convenient manner or performs interface operation. Therefore, the present provides a convenient way for the user to use two input modes with a single cursor input device.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A cursor input device with dual input modes, comprising:
a control computing module, having at least a microprocessor;
a coordinate sensing module, having a touch sensing loop unit and an electromagnetic sensing loop unit;
a first analog multiplexing module, driven by said control computing module to activate said electromagnetic sensing loop unit of said coordinate sensing module to scan for signals;
a first signal processing module, for receiving and processing electromagnetic signal scanned by said electromagnetic sensing loop unit of said coordinate sensing module, and transmitting said processed signal to said control computing module;
a second analog multiplexing module, driven by said control computing module to activate said touch sensing loop unit of said coordinate sensing module to scan for signals; and
a second signal processing module, for receiving and processing finger touch signal scanned by said touch sensing loop unit of said coordinate sensing module, and transmitting said processed signal to said control computing module.

2. The device as claimed in claim 1, wherein said touch sensing loop unit and an electromagnetic sensing loop unit of said coordinate sensing module are of a layered structure.

3. The device as claimed in claim 1, wherein said touch sensing loop unit of said coordinate sensing module is of the projected capacitance touch panel type.

4. The device as claimed in claim 1, wherein said control computing module only activate either electromagnetic sensing loop unit or touch sensing loop unit of coordinate sensing module to scan for signals at a time, but not at the same time.

5. The device as claimed in claim 1, wherein said coordinate sensing module is made of a printed circuit board.

6. The device as claimed in claim 1, wherein said coordinate sensing module is made of a soft circuit board.

7. The device as claimed in claim 1, wherein said coordinate sensing module is made by forming related circuit on surface of glass.

8. The device as claimed in claim 1, wherein said control computing module outputs the computed signal data through a transmission interface, and said transmission interface is either of wired or wireless transmission mode.
